(19) United States
(12) Patent Application Publication
(10) Pub. No.: US 2006/0268184 A1
(43) Pub. Date: Nov. 30, 2006

(54) Tuner and slim TV with the same

(75) Inventors: Byung Hyuk Kim, Kyungki-do (KR); Jong Chull Yun, Kyungki-do (KR); Kwang Ju Choi, Seoul (KR); Si Young Kwon, Seoul (KR); Young Ju Jang, Kyungki-do (KR)

Correspondence Address: LOWE HAUPTMAN BERNER, LLP, 1700 DIAGONAL ROAD, SUITE 300, ALEXANDRIA, VA, 22314, US

(73) Assignee: Samsung Electro-Mechanics Co., Ltd., Kyungki-do (KR)

(21) Appl. No.: 11/195,736

(22) Filed: Aug. 3, 2005

(30) Foreign Application Priority Data
May 25, 2005 (KR) 10-2005-44147

(51) Int. Cl. H04N 5/50; H04N 5/64

(52) U.S. Cl. 348/836; 348/731

(57) ABSTRACT

A slim TV includes a monitor panel defining a front portion of the slim TV, a printed circuit board (PCB) mounted on a rear surface of the monitor panel, a rear cover enclosing the printed circuit board, the rear cover having a main body and a flange bent from the rear cover toward the monitor panel, and a tuner mounted on the PCB board to convert an RF signal into an IF signal. The tuner includes a chassis for receiving an electric circuit board, an antenna input terminal projected out of the chassis through a front part of the chassis in a direction perpendicular to the main body of the rear cover, the front part of the chassis being in parallel with the main body of the rear cover, and terminal pins projected out of the chassis in a direction opposite to that in which the antenna input terminal is projected.

### RELATED APPLICATION

The present application is based on, and claims priority from, Korean Application Number 2005-44147, filed May 25, 2005, the disclosure of which is hereby incorporated by reference herein in its entirety.

### BACKGROUND OF THE INVENTION

1. Field of the Invention

The present invention relates to a tuner that can be associated with a slim TV such as a liquid crystal display (LCD) TV and a plasma display panel (PDP) TV, and more particularly, to a tuner for a slim TV, which is designed to be mounted in a small space defined in a slim TV without using a sub-connector such as an antenna support connector, thereby making an efficient use of a space for mounting electronic components and saving production costs. The present invention further relates to a slim TV with such a tuner.

2. Description of the Related Art

Generally, a TV tuner is designed to separate video and audio signals from each other and output the separated video and audio signals by receiving a radio frequency (RF) signal through an antenna, converting the received RF signal into an intermediate frequency (IF) signal and demodulating the IF signal.

Such a tuner includes a chassis defining an outer body and an electric circuit board disposed in the chassis. The electric circuit board includes an input filter allowing only an RF band to pass therethrough and filtering other frequencies, a single tuned circuit, an amplifier for amplifying an input signal, a double tuned circuit, and a mixed circuit having a mixer generating the IF frequency.

FIG. 1A shows a CRT TV where a conventional TV tuner is mounted.

As shown in FIG. 1A, a CRT TV 110 provides a sufficient space for mounting a TV tuner 100.

In the typical CRT TV 110, a PCB 140 is horizontally arranged in the CRT TV 110. In addition, as shown in FIG. 1B, an antenna input terminal 122 is formed on a lateral part of a tuner chassis 120 and terminal pins 130 are formed on another lateral part of the tuner chassis 120. The terminal pins 130 are coupled to the PCB that is horizontally disposed in the CRT TV 110.

That is, in order to easily couple the conventional TV tuner 100 to the PCB 140 that is horizontally disposed and to allow the antenna input terminal 122 extends horizontally out of a rear cover of the CRT TV 110, the antenna input terminal 122 and the terminal pins 130 must be provided on the lateral parts of the tuner chassis 120.

As described above, in the case of the CRT TV 110, it is effective to form the antenna input terminal 122 and the pins 130 are formed on the lateral parts of the chassis 120. That is, there is no need of forming the antenna input terminal 122 and the terminal pins 130 on a front or rear part of the chassis 120.

In the typical CRT TV 110, an RF signal is inputted from an outer antenna wire 124 to the antenna input terminal 122 and the inputted RF signal is converted into an IF signal by an electric circuit disposed in the tuner 100. The converted IF signal is transmitted to the PCB 140 disposed in the CRT TV 110 through the terminal pins 130.

Meanwhile, in recent years, instead of the CRT TV, a slim TV such as an LCD TV and a PDP TV has been widely commercialized as it has an advantage of making the efficient use of a space.

Such a slim TV has many advantages in terms of a variety of aspects. However, since it has a reduced thickness, there is a limitation in effectively installing a variety of electronic components constituting the slim TV.

FIG. 2 shows a typical slim TV 200 where a conventional TV tuner is applied.

As shown in FIG. 2, a typical slim TV 200 includes a monitor panel 210 defining a front portion of the slim TV 200. In order to reduce the thickness of the slim TV 200, a PCB 212 is vertically mounted on a rear surface of the monitor panel 210. A TV tuner 220 is mounted on a rear surface of the PCB 212 and a rear cover 214 is provided to protect the PCB 212 and the slim TV tuner 220.

FIGS. 3A and 3B show the conventional slim TV tuner 220 depicted in FIG. 2.

As shown in FIGS. 3A and 3B, the tuner 220 includes a chassis having a front part 222 and a lateral part 222a bent at right angles from the front part 222. An antenna input terminal 230 is projected through a portion of the lateral part 222a of a chassis. Terminal pins 240 are projected from a rear part of the chassis.

Since the PCB 212 is vertically disposed in parallel with the monitor panel 210, the tuner 220 is disposed in parallel with the PCB 212 in a state where the terminal pins projected from the rear part of the chassis are coupled to the PCB 212. In addition, the antenna input terminal 230 is also disposed in parallel with the monitor panel 210 and the PCB 212. This structure is very effective in reducing an overall thickness of the slim TV 200.

In addition, the antenna input terminal 230 that is in parallel with the PCB 212 of the slim TV 200 is to be disposed in parallel with the rear cover 214 and projected out of a underside or lateral side of the rear cover 214.

Therefore, there is a need to provide an antenna insertion slot (not shown) on the underside or lateral side of the rear cover 214 so that an outer antenna wire 260 can be connected to the antenna input terminal 230 through the antenna insertion slot. The connection of the outer antenna wire 260 to the antenna input terminal 230 through the antenna insertion slot is troublesome for a worker and time-consuming. In addition, since a direction where the outer antenna wire 260 is connected to the antenna input terminal 230 is limited by the underside or lateral side of the rear cover 214, there is a limitation in arranging a variety of electronic components and the tuner 220 in the slim TV 200.

To solve the problems, as shown in FIGS. 3A and 3B, an antenna support connector 270 formed in a L-shape is used so as to extend the antenna input terminal 230 out of the rear cover 214 of the slim TV 200 in a direction perpendicular to a main body of the rear cover 214.

As a result, since the antenna input terminal 230 can be exposed out of the rear cover 220 of the slim TV by the antenna support connector 270 in a direction perpendicular to the main body of the rear cover 214, the worker can easily connect the outer antenna wire 260 to the antenna support connector 270.

The use of the antenna support connector 270 enables the overall thickness of the slim TV 200 to be reduced and eliminates the limitation in arranging the variety of electronic components.

However, the use of the additional L-shaped antenna support connector 270 causes the increase of the manufacturing costs of the tuner 220. Furthermore, since there is a need to assemble the L-shaped antenna support connector 270 to the antenna input terminal 230, the number of assembling processes is increased, thereby deteriorating the productivity.

In addition, the L-shaped antenna support connector 270 occupies an internal space of the slim TV 200. This may affect on the design and arrangement of other electronic components and have a bad influence upon reduction in the thickness and weight of the slim TV 200.

### SUMMARY OF THE INVENTION

Accordingly, the present invention is directed to a tuner and a slim TV with the same that substantially obviate one or more problems due to limitations and disadvantages of the related art.

An object of the present invention is to provide a slim TV tuner with an improved chassis, which is designed to be mounted in a relatively small internal space of a slim TV, thereby making the efficient use of space.

Another object of the present invention is to provide a slim TV tuner with an improved chassis, which is designed to expose an antenna input terminal exposed out of a rear cover of a slim TV without using additional part, thereby saving the manufacturing costs and improving the productivity.

Still another object of the present invention is to provide a slim TV with such a tuner.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a slim TV tuner for converting an RF signal into an IF signal in a slim TV, the slim TV tuner including: a chassis for receiving an electric circuit board; an antenna input terminal projected out of the chassis through a front part of the chassis to transmit the RF signal inputted to the electric circuit board; and terminal pins projected out of the chassis in a direction opposite to that in which the antenna input terminal is projected, the terminal pins being electrically connected to the electric circuit board and outputting the IF signal to the slim TV.

Preferably, the antenna input terminal may be projected out of the chassis in a direction perpendicular to the front part.

Further preferably, the slim TV tuner may further include a cover plate provided with an aperture in which the antenna input terminal is fitted and coupled to the chassis to cover the electric circuit board therein.

Still further preferably, the chassis may be designed to mount additional video and audio modulating terminals.

According to another aspect of the present invention, there is provided a slim TV comprising: a monitor panel defining a front portion of the slim TV; a printed circuit board (PCB) mounted on a rear surface of the monitor panel; a rear cover having a main body to enclose the printed circuit board; and a tuner mounted on the PCB board to convert an RF signal into an IF signal, wherein the tuner comprises: a chassis for receiving an electric circuit board; an antenna input terminal projected out of the chassis through a front part of the chassis in a direction perpendicular to the main body of the rear cover, the front part of the chassis being in parallel with the main body of the rear cover; and terminal pins projected out of the chassis in a direction opposite to that in which the antenna input terminal is projected.

Preferably, the chassis is formed in a box-shape and the front part of the chassis defines a largest surface of the box-shape.

Further preferably, the antenna input terminal may be projected out of the rear cover through a slot formed on the main body of the rear cover.

Still further preferably, the chassis may be designed to mount additional video and audio modulating terminals.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1A is a partially broken side view of a conventional tuner mounted on a cathode ray tube (CRT) TV;

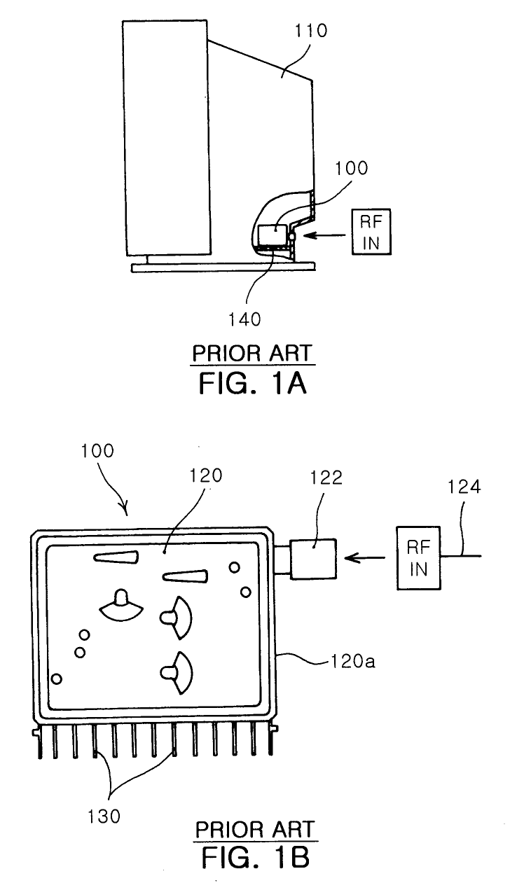

FIG. 1B is a side view of a tuner depicted in FIG. 1A;

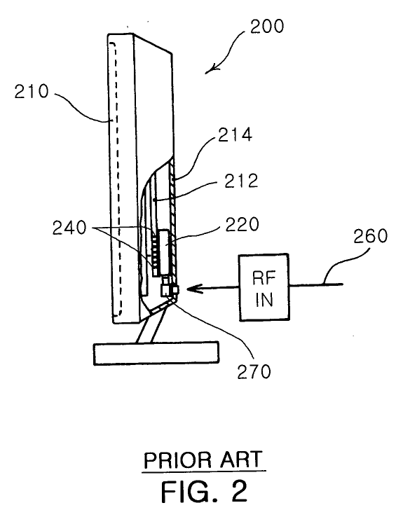

FIG. 2 is a partially broken side view of a conventional tuner mounted on a slim TV;

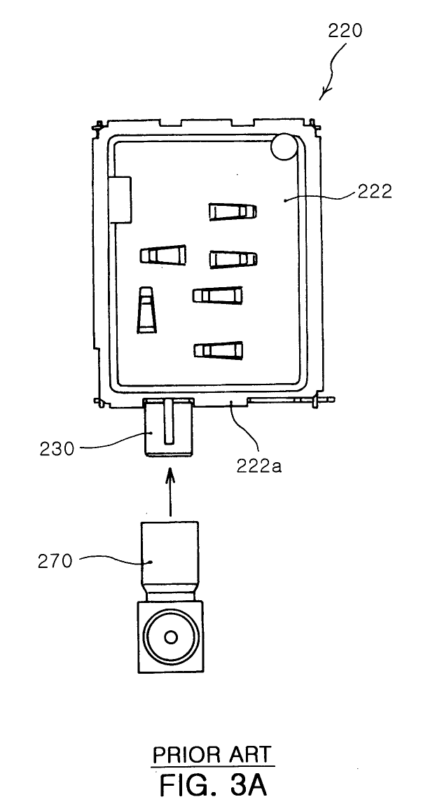

FIGS. 3A and 3B are respectively front and side views of a structure for connecting an antenna support connector to a conventional slim TV tuner depicted in FIG. 2;

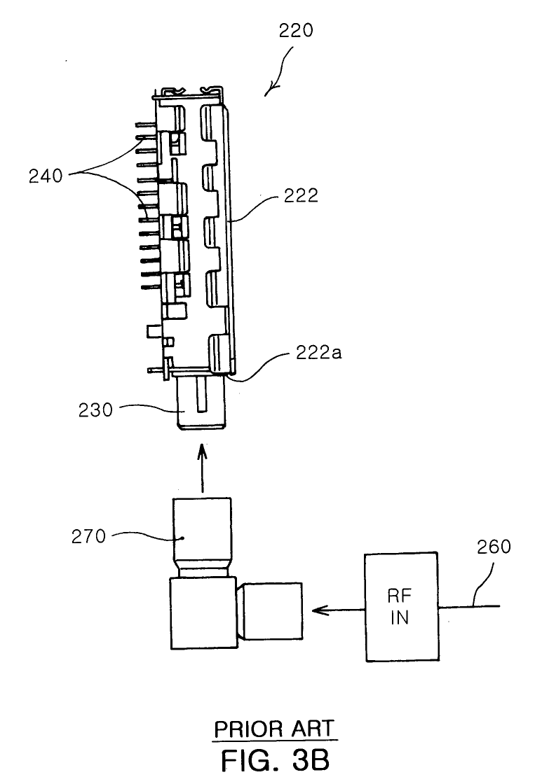

FIG. 4 is a partially broken side view of a slim TV where a slim TV tuner with an improved chassis according to an embodiment of the present invention is employed;

FIG. 5 is an exploded perspective view of a slim TV tuner with an improved chassis according to an embodiment of the present invention; and

FIGS. 6A to 6C are respectively front, side and plane views of an outer structure of a slim TV tuner with an improved chassis according to an embodiment of the present invention.

### DETAILED DESCRIPTION OF THE INVENTION

Reference will now be made in detail to the preferred embodiments of the present invention, examples of which are illustrated in the accompanying drawings.

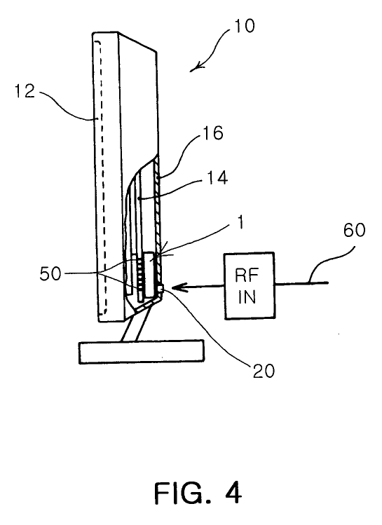

FIG. 4 shows a slim TV where a slim TV tuner according to an embodiment of the present invention is employed.

A slim TV 10 includes a monitor panel 12 defining a front portion of the slim TV 10, a PCB 14 mounted on a rear surface of the monitor panel 12, and a rear cover 16 enclosing the PCB 14. The rear cover 15 includes a main body and a flange bent and extending from the main body toward the monitor panel 12.

The slim TV 10 further includes a tuner 1 for converting an RF signal into an IF signal.

The slim TV tuner 1 is mounted inside the rear cover 16 of the slim TV 10. The slim TV tuner 1 has an antenna input terminal 20. The antenna input terminal 20 is projected out of the rear cover 16 in a direction perpendicular to the main body of the rear cover 16.

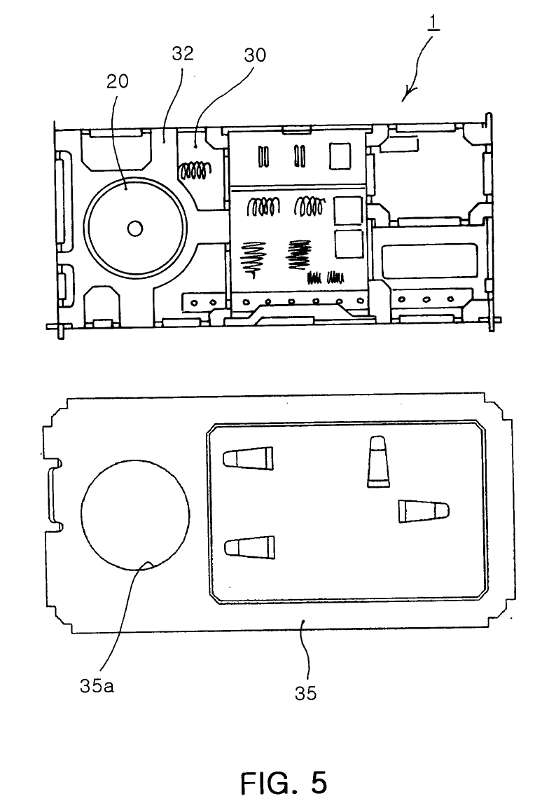

FIG. 5 shows in detail the slim TV tuner depicted in FIG. 4.

As shown in FIG. 5, the slim TV tuner 1 includes a chassis 32 in which an electric circuit board 30 is disposed. The chassis 32 is formed by press-punching a steel plate in a predetermined shape. The punched steel plate is then bent in a tetragonal box-shape, preferably in a regular tetragonal or rectangular box-shape. The electric circuit board 30 forming electric circuits is disposed in the box-shaped chassis 32.

The electric circuit board 30 is typically comprised of an input filter, a single tuned circuit, an amplifier, a double tuned circuit, and a mixed circuit to convert the RF signal transmitted from the antenna input terminal 20 into the IF signal and transmit the converted IF signal to the terminal pins 50.

The chassis 32 includes a front part facing the main body of the rear cover 16 and defining a largest surface and a lateral part bent from the front part. The antenna input terminal 20 is mounted on the chassis 32 such that it can be projected through the front part of the chassis 32. That is, the antenna input terminal 20 is projected out of the chassis 32 through the front part facing the main body of the rear cover 16. A cover plate 35 provided with an aperture 35a in which the antenna input terminal 20 can be fitted is coupled on the front part of the chassis 32.

That is, the antenna input terminal 20 is projected in a direction perpendicular to the front part of the chassis 32 to receive the RF signal and to transmit it to the electric circuit of the board 30.

The cover plate 35 is provided to more securely fix the antenna input terminal on the chassis 32 by allowing the antenna input terminal 20 to be fixedly fitted in the aperture 35a. In addition, the cover plate 35 functions to prevent foreign objects from being introduced into the chassis 32.

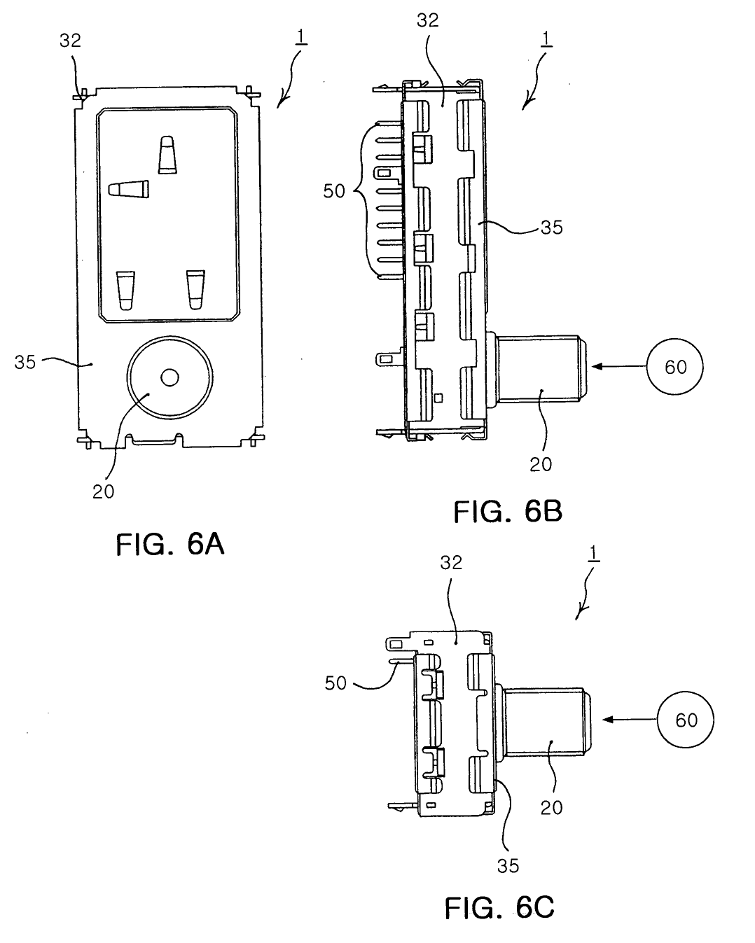

Referring to FIGS. 4, 6B and 6C, terminal pins 50 are projected from the electric circuit board 30 out of the chassis 32 in a direction opposite to that in which the antenna input terminal 20 is projected. The terminal pins 50 are connected to the PCB 14 of the slim TV 10 to output the IF signal to the PCB 14.

The terminal pins 50 are comprised of IF output pins outputting the IF signal converted from the RF signal, power supply pins supplying power to the electric circuit and data input/output pins interfacing the electric circuit with the PCB 14.

Therefore, the terminal pins 50 are inserted in corresponding locations of the PCB 14 of the slim TV 10.

The chassis 32 may be designed to mount additional video and audio modulating terminals (not shown) to transmit video and audio signals to the slim TV 10.

As described above, when the inventive slim TV tuner 1 is applied to the slim TV 10, the worker can easily connect the outer antenna wire 60 to the antenna input terminal 20.

That is, as shown in FIG. 4, when the inventive slim TV tuner 1 is mounted inside the rear cover 16 of the slim TV 10, the antenna input terminal 20 is projected in the perpendicular direction out of the main body of the rear cover 16.

The terminal pins 50 is electrically coupled to the PCB 14 of the slim TV 10 while the antenna input terminal 20 is projected out of the main body of the rear cover 16 in a perpendicular direction and connected to the outer antenna wire 60 to receive the RF signal.

According to the slim TV tuner of the present invention, since the antenna input terminal 20 is projected in a perpendicular direction out of the main body of the rear cover 16 without using any connector, the worker can easily connect the outer antenna wire 60 to the antenna input terminal 20 during the assembling process.

Furthermore, since a space that has been used for a prior antenna support connector can be utilized for installing other electric components, the space can be efficiently utilized, thereby improving the degree of design free of electric components mounted in the slim TV 10 and efficiently arranging the electric components.

According to the present invention, since there is no need for a L-shaped antenna support connector that has been used in the prior art, the inventive slim TV tuner can be mounted in a relatively small internal space of the slim TV, thereby making the effective space use for other electric components.

Furthermore, since the inventive slim TV tuner is designed in a simple structure, the manufacturing costs can be saved and the productivity can be improved by reducing the assembling time.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A slim TV tuner for converting an RF signal into an IF signal in a slim TV, comprising:
a chassis for receiving an electric circuit board;
an antenna input terminal projected out of the chassis through a front part of the chassis to transmit the RF signal inputted to the electric circuit board; and
terminal pins projected out of the chassis in a direction opposite to that in which the antenna input terminal is projected, the terminal pins being electrically connected to the electric circuit board and outputting the IF signal to the slim TV.

2. The slim TV tuner of claim 1, wherein the antenna input terminal is projected out of the chassis in a direction perpendicular to the front part.

3. The slim TV tuner of claim 1, further comprising a cover plate provided with an aperture in which the antenna input terminal is fitted and coupled to the chassis to cover the electric circuit board therein.

4. The slim TV tuner of claim 1, wherein the chassis is designed to mount additional video and audio modulating terminals.

5. A slim TV comprising:
a monitor panel defining a front portion of the slim TV;
a printed circuit board (PCB) mounted on a rear surface of the monitor panel;
a rear cover having a main body to enclose the printed circuit board; and
a tuner mounted on the PCB board to convert an RF signal into an IF signal,
wherein the tuner comprises:
a chassis for receiving an electric circuit board;
an antenna input terminal projected out of the chassis through a front part of the chassis in a direction perpendicular to the main body of the rear cover, the front cover of the chassis being in parallel with the main body of the rear cover; and
terminal pins projected out of the chassis in a direction opposite to that in which the antenna input terminal is projected.

6. The slim TV of claim 5, wherein the chassis is formed in a box-shape and the front part of the chassis defines a largest surface of the box-shape.

7. The slim TV of claim 5, wherein the antenna input terminal is projected out of the rear cover through a slot formed on the main body of the rear cover.

8. The slim TV of claim 5, wherein the chassis is designed to mount additional video and audio modulating terminals.
